(19) United States
(12) Patent Application Publication
(10) Pub. No.: US 2013/0346839 A1
(43) Pub. Date: Dec. 26, 2013

(54) PRIVATE TUNNEL NETWORK PORTAL

(71) Applicant: Francis Dinha, Dublin, CA (US)

(72) Inventor: Francis Dinha, Dublin, CA (US)

(21) Appl. No.: 13/562,111

(22) Filed: Jul. 30, 2012

Related U.S. Application Data
(63) Continuation-in-part of application No. 13/528,682, filed on Jun. 20, 2012.

(51) Int. Cl. G06F 15/173; G06F 17/00

(52) U.S. Cl. 715/205; 709/226

(57) ABSTRACT

A system and method for a portal for management and operation of a private tunnel network computing system. The portals provide for establishing, modifying, and operating multiple private clouds through a single interface. In some embodiments the method includes receiving resource information such as private and public resources and presenting the resource information to a manager through a graphical interface. The network manager then selects a resource and a private cloud, also through a graphical user interface. Once selected, a manager can operate to add the resource to the private cloud, or alternatively drop the resource from the cloud. Multiple private clouds may be effectuated and membership in those clouds established through the user interface. The private tunnel network portal may include controls for management tools, developer tools, and a cloud applications store. Once established, non-manager users can access those resources in a secure environment.

### RELATED APPLICATIONS

This application is a continuation-in-part of U.S. patent application Ser. No. 13/528,682 entitled “Private Tunnel Network” by the same inventor filed Jun. 20, 2012 which is hereby incorporated by reference as if fully set forth herein.

### BACKGROUND

One means of secure communications through the Internet is through the use of a virtual private network (VPN). This private network interconnects remote networks through public communication infrastructures such as the Internet. VPNs provide security through tunneling protocols and security procedures using encryption. Conventional uses of VPNs include securely connecting the branch offices of a bank to a head office network over the Internet. A VPN can also be used to interconnect two similar-type networks over a dissimilar middle network for example, thus alleviating interconnectivity issues.

In general there are two major types of VPNs: remote-access VPNs and Site-to-site VPNs. Remote-access VPNs let individual users connect to a remote network. Site-to-site VPNs allow inter-connection of networks of multiple. VPNs reduce costs by eliminating the need for dedicated leased lines between networks, because they use existing, lower cost, infrastructure to connect networks while, at the same time, adding a layer of security.

VPNs conventionally require remote users to be authenticated and make use of encryption techniques to prevent disclosure of private information to unauthorized parties. VPN users are able to access functionalities across networks, such as remote access to resources like files, printers, databases or internal websites in a secure manner.

Once connected, a VPN creates a so-called tunnel through the Internet. Tunnel endpoints generally authenticate before secure VPN tunnels can be established to ensure a proper tunnel exists. VPNs may use passwords, biometrics, two-factor authentication or other cryptographic methods to secure the tunnel. Network-to-network tunnels may also use digital certificates to allow the tunnel to establish automatically and without intervention from the user.

### SUMMARY

Disclosed herein is a processor-based system and method for a portal for operation of a private tunnel cloud computing network. The portal provides for establishing, modifying, and operating multiple private clouds through a single interface. In some embodiments the method includes receiving resource information such as private and public resources and presenting at least a portion of said resource information to a user through a graphical interface. The private or public nature of the resource may depend on the resources ability to communicate through a virtual private network (VPN). In some embodiments both private and public resources may be employed in a single private cloud.

Initially an administrator of the private cloud network selects a resource and designates an activity for relating the resource to a specific private cloud. The relating step may be to add, remove, or update the resource's membership in a private cloud. The selection of the resource, private cloud, and activity is affected through a graphical user interface which may be on a browser display.

Multiple private clouds may be effectuated and membership in those clouds established through the user interface. Membership may be controlled through multiple password schemes. In operation a user may log into a private tunnel portal and see one or more resources arranged according to membership in one or more private clouds. Drag and drop or other selection means may be employed to move resources among the private clouds. Each private cloud may operate independently of other private clouds even when displayed through a single portal. The private tunnel network portal may include controls for management tools, developer tools, and a cloud applications store.

In some embodiments a user portal may be effectuated wherein a user gains access to, and can operate within the private cloud framework. In these embodiments a user operates applications, web sites and other resources added to the private cloud network. Other embodiments may include a management portal. The management portal may include tools for setting up the private tunnel network including but not limited to, adding resources, adding members, setting authentication requirements and the like.

### BRIEF DESCRIPTION OF THE DRAWINGS

FIG. 1 shows a private tunnel network with multiple private clouds.

FIG. 2 shows a representative user interface that may be employed in certain embodiments.

FIG. 3 shows a method for certain embodiments according to the present disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### Lexicography

The term “application programming interface” or “API” generally refers to a code-based specification intended to be used as an interface by software components to communicate with each other. An API may include specifications for routines, data structures, object classes, and variables.

The term “HTML Injection” generally refers to injecting HTML code into a web server's response to alter the content to the end user. This may also be known as cross site scripting.

The term “encapsulate” generally refers to a method of designing communication protocols in which logically separate functions in the network are abstracted from their underlying structures by inclusion or information hiding within higher level objects. Typically the more abstract layer is often called the upper layer protocol while the more specific layer is called the lower layer protocol.

The term “encryption” generally refers to the process of transforming information (referred to as plaintext) using an algorithm (called a cipher) to make it unreadable to anyone except those possessing special knowledge, usually referred to as a key. The result of the process is encrypted information (or ciphertext). The reverse process, making the encrypted information readable again, is generally referred to as decryption. The word encryption may also refer to the reverse process as well. For example, “software for encryption” often performs decryption.

The term “extension” and “browser extension” and the like generally refer to a computer program, applet or instructions that extend the functionality of a web browser in some way. Depending on the browser, the term may be distinct from similar terms such as plug-in or add-on.

The term “host machine” generally refers to a single processor-based machine that includes the elements of the system under discussion. However, this disclosure should not be read to limited a host machine in that manner when one having skill in the art will recognize that one or more of those elements may be performed remotely.

The term “Private Cloud” refers generally to a collection of computer resources and services which are coupled together either locally, remotely or some combination thereof, but the coupling limits access to a predefined user or group of users.

The term “Public IP Address” generally refers to a valid IP address that falls outside any of the IP address ranges reserved for private uses by Internet standards groups.

The terms “software as a service” or “SaaS” or “on-demand software” generally mean a software delivery model in which software and its associated data are hosted centrally such as on the Internet or cloud and accessed by users using a client. SaaS is a common delivery model for many business applications, including accounting, collaboration, customer relationship management (CRM), management information systems (MIS), enterprise resource planning (ERP), invoicing, human resource management (HRM), content management (CM) and service desk management.

The term “structured data” generally refers to data stored in a meaningful fashion such that a processor may be instructed to access the data. Examples include but are not limited to databases, relational databases, text files, XML file and the like.

The term “tunneling” generally refers to network protocol that encapsulates a different payload protocol. The use of tunneling may allow for carrying a payload over an incompatible delivery-network, or providing a secure path through an untrusted network.

The term “wireless device” generally refers to an electronic device having communication capability using radio, optics and the like.

The term “virtual machine” or “VM” generally refers to a self-contained operating environment that behaves as if it is a separate computer even though it is part of a separate computer or may be virtualized using resources form multiple computers.

The terms “virtual private network” and VPN generally refer to a private network that interconnects remote (and often geographically separate) networks and devices through primarily public communication infrastructures such as the Internet. VPNs provide security through tunneling protocols and security procedures such as encryption.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touch screens, displays and terminals as well as remote connected computer systems, modems, radio transmitters and handheld personal communication devices such as cellular phones, “smart phones” and digital assistants.

Certain embodiments may include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless devices such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

Client-server processing includes, but is not limited to operations between multiple processor-based devices wherein the processing is partially performed on different computing devices. Conventionally a server is coupled to one or more databases and to a network, although the present disclosure need not be limited in that way.

A client-server system may rely on “engines” or “agents” which include processor-readable instructions (or code) to effectuate different elements of a design. Each engine may be responsible for differing operations and may reside in whole or in part on a client, server or other device. As disclosed herein certain embodiments may include a display engine, a data engine, an interface engine, a user interface and the like. For example and without limitation, engines and agents may do one of more of the following:
Seek and gather information, including information about events, from remote data sources;
Display, or cause to be displayed, information to a user;
Perform calculations;
Store data locally and/or remotely.

### Private Tunnel

A private tunnel network (PTN) provides a framework for effectuating private clouds for the purpose of enterprises such as Application Providers, Service Providers, Private Businesses, and the like to utilize a private tunnel service. The establishment of a private tunnel between a client and an application/service provider may be for providing web services, specific applications, unified threat management (UTM), firewall, and other services through the private tunnel. The PTN includes a predetermined communication protocol, systems for providing and managing PTN addresses, and systems for providing and managing encryption certificates for authenticating associated resources. The PTN may employ conventional techniques such as those found in virtual private networks (VPNs) to maintain security. In operation each logical device on the PTN network has a unique PTN address.

### Private Cloud

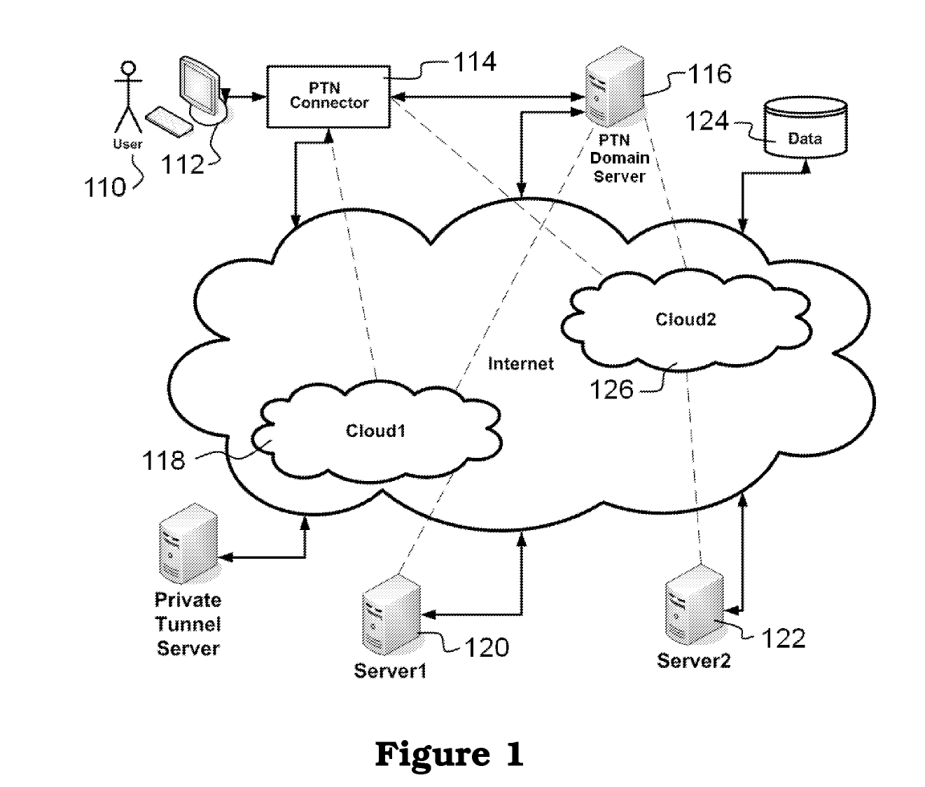

FIG. 1 shows a private tunnel network with multiple private clouds. As disclosed herein a private cloud may be effectuated by creating a private network having controlled access to shared services and resources. A user 110 using a host machine 112 is coupled to a PTN Connector 114. Each user 110 in the private cloud may have access to the resources and services exported by the administrator of the private cloud. The Administrator 110 exporting resources may have the ability to granularly control which of the other users can access which of the exported resources and services.

A PTN domain server 116 is coupled to a PTN connector 114. As described herein the PTN connector 114 may operate to provide VPN connectivity to the PTN domain server 116. The PTN domain server 116 maintains information of all devices associated with a particular cloud (a cloud domain). For example and without limitation if the user 110 wants to have a private cloud 118, the PTN domain server 116 keeps the appropriate IP information for all the resources in the private cloud 118. By way of example only, private cloud 118 may include Server1 120 and Server2 122, while private cloud 126 may include Server1 102, server2 122 and data source 124. Users 110 may be associated with multiple private clouds and private clouds may have multiple users. Accordingly the PTN domain server 116 may maintain structured data including cloud resource information, cloud user information, encryption information and related information required to maintain cloud identification.

In operation the PTN domain server 116 receives a message (traffic) from a user, generally through a PTN connector or its equivalent. In certain embodiments the PTN domain server 116 may do one or more of the following:
Direct the traffic to one or more resources or services in the private cloud;
Provide signaling and control functions for operation of the private cloud;
Receive traffic, decode the traffic and forward to public resources and services.
   One having skill in the art will appreciate that this list is not exhaustive and should not limit the operation of the PTN domain server in any way. For example and without limitation, in certain embodiments the users communicate directly without the need for traffic to pass through the PTN Domain server 116.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### PTN Portal

A PTN portal may include a user interface that allows an administrator to track any connected devices and resources, as well as manage access to resources and services. The portal may be effectuated as a web-based interface to the local PTN Connector or LAN Gateway. With the portal a user can visualize devices on the same private cloud which are running PTN connectors or LAN Gateways, and, in certain embodiments, browse resources or services on the private cloud. Using the portal may allow a user to command the PTN Connector or Gateway to perform specific tasks, such as joining a particular private cloud, managing credentials and other tasks as set forth herein.

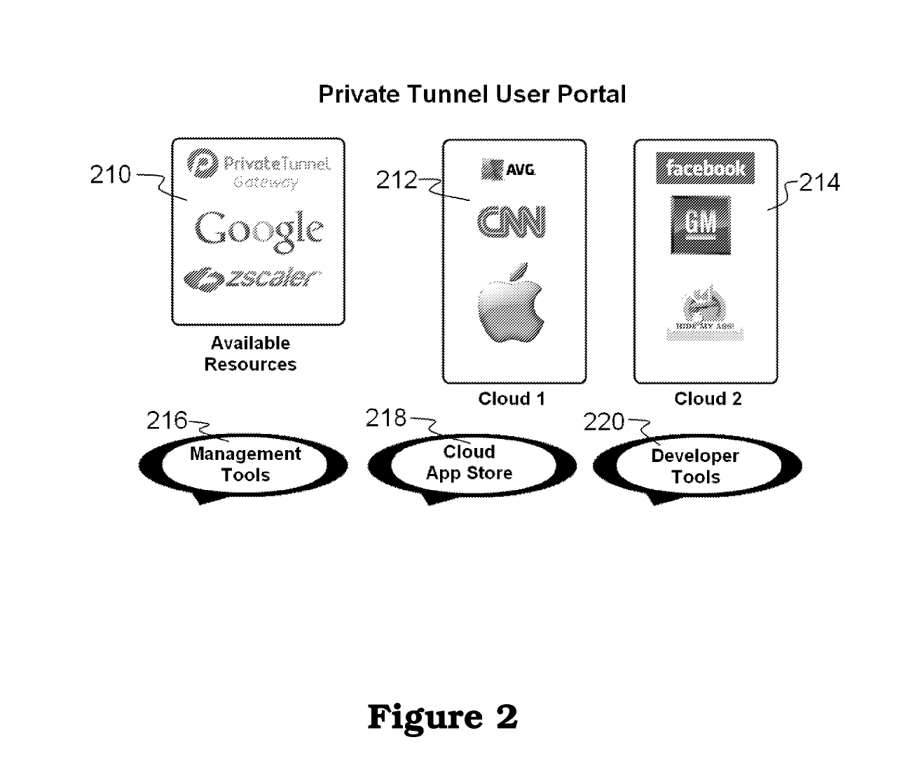

FIG. 2 shows a representative user interface that may be employed in certain embodiments. The user interface may be generated by a display engine and presented to a user through a web based UI. In FIG. 2 a user is presented with a selection of resources 210, and resources associated with specific private clouds such as Cloud 1 212 and Cloud 2 214. To add a resources to a private cloud the user, using a mouse or other indication process, selects the resource indicia and “drags” the resource icon into a screen area that represents a private cloud. While the selection of resources 210 is shown as a collection of images on a screen, the resource selection may be effected by using any Web based UI to locate a resource and injecting code into the browser to allow for user selection of the resource. The selection and indication of a resource to a specific private cloud operates to associate that resource to a private cloud.

One having skill in the art will recognize that the images shown in FIG. 2 may be hyperlinked images allowing for interaction with remote sites or the control of specific features of the display. For example and without limitation, clicking on an image represented as belonging to a specific private cloud may trigger code instructing a Web interface to interact with that resource. In other embodiments, right clicking on an image, or dragging an image to a specific image or area of the screen will affect different operations.

The association process may be controlled by user setting described herein together with the nature of the specified private cloud. In a representative embodiment the IP address of the resource is entered into a PTN domain server where it is associated with a specific cloud. A user logging into a private tunnel portal sees the private clouds and selects the resource in the private cloud they want to interact with. Resources in a cloud may be public to all members of a cloud, or personal such as a private file storage area. By way of example only, a resource might be a file sharing address/port, web server address/port, data base, files, and the like. The owner/administrator of a resource can define access control rules, subject to the cloud access control rules defined by the cloud administrator. These rules may include allowing or denying access from other members of the cloud.

The private cloud may operate through a PTN connector and a private tunnel directly to the cloud resource. In the event the resource is not operative for private tunneling, a server may operate to provide a tunnel to the user and open communications with the resource. For example and without limitation, a user may connect to a PTN server using secure end-to-end communications while the PTN server (or other comparable machine) connects to the public Internet and passes traffic to the user. Thus the private tunnel extends through a first secure portion into the public domain. The PTN user sees publicly available resources such as social networks (Facebook, Twitter and the like), search engines (Google, Bing and the like), news sites, and blogs. Furthermore the PTN server may be operable to remove identifying information from traffic to the public Internet. In certain embodiments using the tools and procedures disclosed herein, a user may access a PTN server using a locally stored IP address, thus obviating the need to access a public DNS server.

The portal may also be used by an application provider, service provider, private business, and enterprise to deliver specific applications and services to end users. For example and without limitation, Facebook might offer a Facebook application on a private tunnel portal enabling a user to connect through a private tunnel to a Facebook cloud and access its services privately. This has the effect of completely eliminating “man-in-the-middle” attacks of snooping and further eliminating hackers access to the publically exposed Facebook source web code. A hacker may be prevented from injecting malicious code because the private tunnel is a private and secure tunnel between a user and Facebook thus forcing a user to be authenticated before getting access to Facebook's web servers into its private network.

### Management Tools

Certain embodiments may include a management (or control) portal. The Private Tunnel Control Portal may include indicia for controls related to the management of the private clouds. These management tools 216 include but are not limited to creating, renaming, updating, deleting and the like. For example and without limitation these tools may also be used to create a new private cloud, and then invite other users to join this new cloud. Invitations can be extended to other users, who can use the predetermined credentials to identify and authenticate themselves to a new private cloud. The private cloud owners/providers might also allow any users (without invitation) utilizing private tunnel access to its services/applications. In some embodiments a private cloud owner/provider may operate its own registration and authentication system.

In some embodiments a private tunnel network may be established using “drag and drop” techniques. This provides for a user selecting a resource from a predetermined list of resources which may include a web-based user interface, a list display, desktop icons and the like. By selecting the resource, an event is triggered for capturing the resource information. Dropping the resource onto a predefined interface area indicative of a private tunnel network triggers an event to associate that particular resource with the private tunnel network. This may include storing the resource identification and access information into a structured data source, collecting and storing authentication information, and collecting and storing cloud identification information. One having skill in the art will appreciate that although “drag and drop” is used to explain this process, different computer operating systems have different schemes for selecting and working with files/icons and this process may be effected using different operations.

In some embodiments a private cloud may be hosted on a PTN Server such that a user logs into the server using supplied credentials and sees the private cloud interface. From there, the user may access any private cloud resource. In some embodiments a user connects to a private cloud using a user's PTN address. This PTN address would normally be a member of that private cloud to facilitate admittance. Upon successful user authentication (for example a web login) an authenticator adds the user's unique PTN address into the private cloud configuration as a member allowing the PTN user to connect to the cloud. Certain embodiments may also employ independent encryption authenticated for each connection. Once a user is a member of a private cloud, the user may connect to the private cloud and its associated members if their resources are exposed to the cloud. A connection may be initiated by first looking up a PTN server hosting the desired private cloud configuration.

The management tools 216 may allow for regular users and multiple types of privileged users such as administrators, authenticators, and the like. For example and without limitation, administrators may have superior privileges allowing them to change any of private cloud configuration parameters while authenticator roles may be limited. Administrators may also act as authenticators. Administrators that own a particular cloud can define access control rules that prevent members from sharing their resources with the rest of the cloud. The administrator may manage access control over available resources in the cloud.

Certain management tools 216 provide for encryption schemes for the private clouds. Private clouds may be controlled using a single encryption key for each cloud. Multiple private clouds would each have their own encryption key. Moreover, the key may only be available to end-users and not to the PTN domain server or administrators. This has the effect of allowing secure communication between users of a private cloud with only those users having the ability to decode the message.

### Cloud App Store

Certain embodiments may include indicia for an “App Store” 218 for providing applications to users for operations on a private cloud. While the inventor contemplates private cloud operations similar to regular Internet operations, applications may be developed that capitalize on the unique features of a private cloud. These features include but are not limited to the private communications channels between each private cloud resource and user. Some of the applications may include one or more of:
Firewall App for businesses & consumers;
URL Filtering App for businesses and consumers;
UTM (unified threat management) App for business and consumers;
IP PBX App for businesses;
Parental Control App for home users.

### Developer Tools

Certain embodiments may include indicia for Developer Tools 220. Clicking this indicia or control provides access to developer tools may include one or more of the following:
Web APIs for Private Tunnel Connect and Private Tunnel network allowing application to invoke those APIs from a single application;
Web tool kits to develop application UI using HTLM5 and other web programming languages.

### Operation

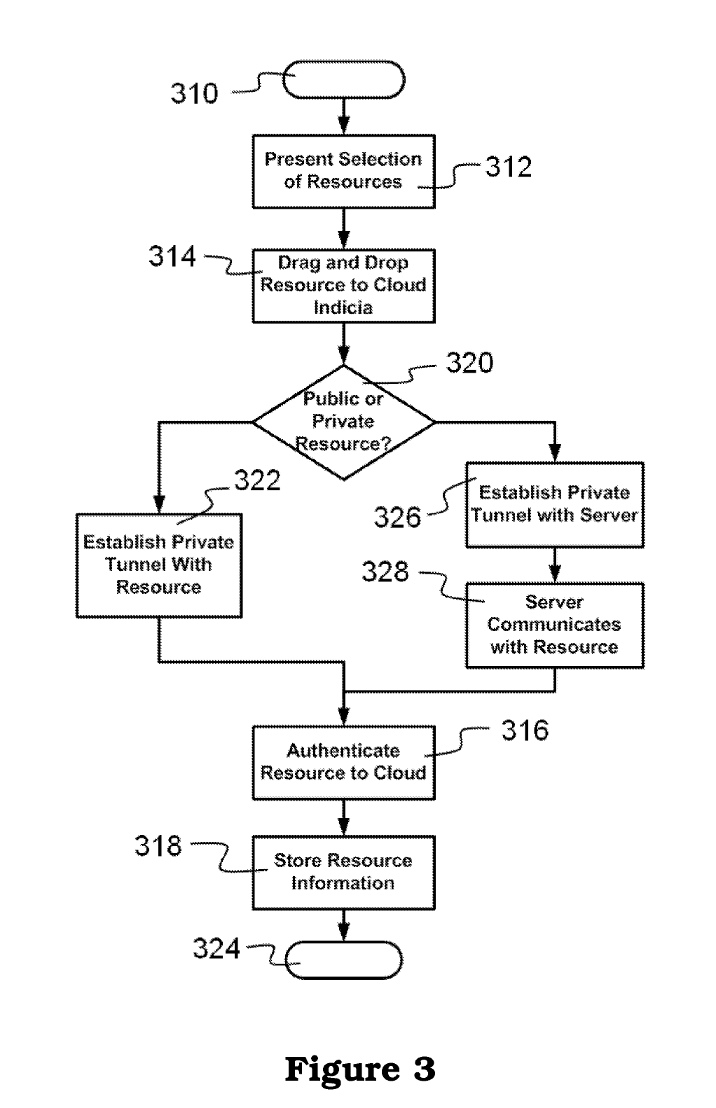

FIG. 3 shows a method for certain embodiments according to the present disclosure. The method begins at a flow label 310.

At a step 312 a presentation of available resources is made to a private tunnel network manager. The presentation may be from a web server listing any resource available on the Internet. Alternatively the resources presented may be from a limited number of resources including but not limited to those already associated with a private cloud.

At a step 314 the manager selects the resource and indicates whether or not to add that resource to a private cloud, create a new private cloud with that resource, or remove that resource from a private cloud. The selection may be in the form of dragging and dropping the resource from one indicia to another, or using other similar processing such as “right clicking” or “tapping” a control to select the resource and/or responding to pop-up command options.

At a step 320 the resource is identified as either a public or a private resource. For this method private resources are those operable to communicate using a private tunnel, while public resources are those resources that do not provide private tunnel support. One having skill in the art will appreciate that a resource may be both private and public in that an API or equivalent code module may be employed to provide private tunnel operability to an otherwise public resource. For example and without limitation, Facebook may provide public services and yet still have a private tunnel interface.

If the resource is operable for private tunnel operation, then flow proceeds to a step 322, otherwise, flow proceeds to a step 326.

At a step 322 the private tunnel relationship is established with the resource. The encapsulation, encryption and any other requirements are established to provide the communications channel.

At a step 326 a private tunnel relationship with a private tunnel server is provided. The private tunnel server is operable to communicate with the private cloud, and for the identified resource, communicate publically.

At a step 328, the private tunnel server established a link with the public resource and may store the linking requirements (i.e. passwords, usernames and the like).

At a step 316 the resource is authenticated to the cloud. Authenticated may include, but is not limited to, associating the cloud name, encryption information, encapsulation information to the resource. Additionally, the authentication may include providing DNS information for operation with a PTN Connector or equivalent instructions.

At a step 318 the resource information of step 316 is stored to a structure data source. Storage may also include user generated content and graphical images to facilitate operation of a private tunnel portal. For example and without limitation, a manager may want to name a specific private cloud or use a variety of icons or graphic for identifying a resource or private cloud. Certain embodiments may operate to receive input from a user designating this information and store it in the structured data source.

At a flow label 324 the method ends.

Once the manager creates a private cloud and adds resources, it is available for regular users. In certain embodiments the user may choose to install various applications and access services provided by those applications.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method comprising:
receiving, at a server, resource information;
presenting a portion of said resource information to a user;
receiving a resource indication from the user, said resource indication related to the resource information;
receiving private cloud information from the user;
receiving association information from the user, said association information relating the resource indication and the private cloud information, and
acting in response to the association information.

2. The method of claim 1 wherein the resource information at least one of either a file sharing address, web address or a database.

3. The method of claim 2 wherein the presenting of the resource information includes presenting a hyperlinked image for display on a web browser.

4. The method of claim 1 wherein the association information includes one of either an indication to add a resource to, or delete a resource from the private cloud.

5. The method of claim 1 further including presenting private cloud information to the user, said private cloud information including an image and a hyperlink associated with the image.

6. The method of claim 1 wherein
the resource information is presented as one or more hyperlinked indicia on a browser interface, and
the private cloud information is presented as one or more hyperlinked indicia on a browser interface.

7. The method of claim 1 wherein said acting in response to the association information includes establishing a private tunnel between the resource and one or more existing private cloud resources.

8. The method of claim 7 wherein said receiving a resource indication and said receiving association information are in response to user controls on a browser interface.

9. The method of claim 1 further including:
receiving an indicia;
modifying the private cloud information to include the indicia, and
storing the modified cloud information in a structured data source.

10. The method of claim 1 further including:
presenting a plurality of indicia, wherein a portion of said indicia are presented as belonging to a first private cloud and a portion of said indicia are presented as belonging to a second private cloud.

11. A device comprising:
a processor;
memory coupled to said processor;
a display engine, said display engine operable to
present resource information and private cloud information, and
receive user commands,
wherein said user commands are operable to operate said resource using said private cloud.

12. The device of claim 11 wherein
the resource information is presented as one or more indicia on a network user interface, and
the private cloud information is presented as one or more indicia on a network user interface.

13. The device of claim 11 wherein the user commands are received from a control on the user interface.

14. One or more processor readable storage devices having processor readable code embodied on said processor readable storage devices, said code for programming one or more processors to perform a method comprising:
receiving resource information from a structured data source;
presenting at least a portion of said resource information to a user;
receiving a resource indication from the user, said resource indication related to the resource information;
receiving private cloud information from the user, and
associating the resource information to the private cloud information.

15. The device of claim 14 wherein the resource information is at least one of either a file sharing address, web address or a database.

16. The device of claim 14 wherein the presenting of the resource information is with hypertext formatted for a browser display.

17. The device of claim 14 wherein the resource information is presented as one or more indicia on a browser interface, and
the private cloud information is presented as one or more indicia on a browser interface.

18. The device of claim 14 wherein said method further includes establishing a private tunnel between the resource and the private cloud.
